(19) United States
(12) Patent Application Publication
(10) Pub. No.: US 2002/0027026 A1
(43) Pub. Date: Mar. 7, 2002

(54) Automatic transmission for electric bicycle

(76) Inventor: Seok-Gi Hong, Kwangju (KR)

Correspondence Address: BURNS DOANE SWECKER & MATHIS L L P, POST OFFICE BOX 1404, ALEXANDRIA, VA, 22313-1404, US

(21) Appl. No.: 09/899,072

(22) Filed: Jul. 6, 2001

(30) Foreign Application Priority Data
Jan. 7, 1999 (KR) 1999-00590
Oct. 22, 1999 (KR) 1999-46135

(51) Int. Cl. B60K 1/00

(52) U.S. Cl. 180/65.2; 180/68.5

(57) ABSTRACT

A motor driven by a battery, a driving member for driving the wheels of the bicycle by the rotational force of the motor, a motive power transmitting device for transmitting the rotational force of the motor to the driving member, a mechanical gearshift device and an electronic gearshift device each for electronically shifting the magnitude of the outputted motive power of the motor according to the magnitude of friction force between the wheels and the ground among other components.

### BACKGROUND OF THE INVENTION

1. Field of the Invention

The present invention relates to an automatic transmission for an electric bicycle and more particularly, an automatic transmission for an electric bicycle running at a constant speed regardless of a difference of friction force between the ground and wheels of the bicycle, which is variable according to various running conditions changed by running circumstances or luggage loaded on the bicycle.

2. Description of the Related Art

Generally, since an electric bicycle is a bicycle of which wheels are driven by electric power, it is used habitually by a person who can not drive the bicycle by his/her own strength such as the old, the weak and the disabled. It is also used by a normal person, when he/she has to move a long distance or carry a heavy load. In addition, since the electric bicycle uses the electric power as a power source, it is environmentally friendly in view of the saving of resources and the preservation of environment.

In such electric bicycle, if the electric power is supplied from a battery to a motor, a rotatory force of the motor is transferred to a wheel of the electric bicycle. A driver changes a speed of the electric bicycle according to various driving conditions.

In a conventional electric bicycle, when an excessive load is applied to the wheels of the bicycle because of driving on an uphill road or in a state that a heavy luggage is loaded on the bicycle, a user has to regulate an output of the bicycle using an electronic device such as a torque sensor so as to reduce the load exerted on the wheels of the bicycle. However, since the output regulating method results in increasing of the load exerted on a side of a motor, there are some problems that the motor is damaged, and the consumption rate of a battery is also increased

Further, since the user has to control the running speed of the bicycle according to the various running conditions, it is too difficult for a beginner or the old and the weak to properly control the speed of the bicycle.

### SUMMARY OF THE INVENTION

It is therefore an object of the present invention to be capable of automatically changing a speed of the electric bicycle according to the load exerted on wheels of the bicycle, thereby preventing the increasing of the load of the motor and saving the consumption rate of the battery.

It is other object of the present invention to be capable of automatically changing a speed of the electric bicycle according to the running conditions, thereby offering convenience to a user.

According to one aspect of the present invention, there is provided an automatic transmission for an electric bicycle, comprising: a motor which is driven by a battery, a driving member for driving a wheel of the bicycle with rotational force of the motor; a power transmitting means for transferring the rotational force of the motor to the driving member; a mechanical gear shifting means for mechanically shifting an output of the motor according to an magnitude of friction force between the wheel and ground and transferring the shifted output of the motor to the driving member; an electronic gear shifting means for electronically shifting the output of the motor according to an magnitude of friction force between the wheel and ground; a moving housing in which the motor, the driving member, the power transmitting means, the mechanical and electric gear shifting means are mounted; a fixed housing which is fixedly disposed at an outer side of the moving housing; and a first rotational shaft which penetrates through the driving member, the moving housing, and is rotatably fixed to the fixed housing, wherein, while the moving housing is revolved with the rotational shaft in the center according to the magnitude of load exerted on the wheel of the bicycle, the output of the motor is changed through the mechanical and electronic gear shifting means and then transferred to the driving member.

According to another aspect of the present invention, it is provided the automatic transmission for the electric bicycle including a motor driven by a battery, a driving member for driving the wheels of the bicycle by the rotational force of the motor, a motive power transmitting device for transmitting the rotational force of the motor to the driving member, an electronic gearshift device for electronically transmitting the outputted motive power of the motor by means of an electronic clutch according to the magnitude of friction force between the wheels and the ground, and a fixed housing including the motor, the driving member, the motive power transmitting device and the electric gearshift devices.

According to other aspect of the present invention, there is provided an automatic transmission for an electric bicycle, comprising: a motor which is driven by a battery; a driving member for driving a wheel of the bicycle with rotational force of the motor; a power transmitting means for transferring the rotational force of the motor to the driving member; a mechanical gear shifting means for mechanically shifting an output of the motor according to an magnitude of friction force between the wheel and ground and transferring the shifted output of the motor to the driving member; a moving housing in which the motor, the driving member, the power transmitting means, the mechanical and electric gear shifting means are mounted; a fixed housing which is fixedly disposed at an outer side of the moving housing; and a first rotational shaft which penetrates through the driving member, the moving housing, and is rotatably fixed to the fixed housing, wherein, while the moving housing is revolved with the rotational shaft in the center according to the magnitude of load exerted on the wheel of the bicycle, the output of the motor is changed through the mechanical gear shifting means and then transferred to the driving member.

According to another aspect of the present invention, there is provided an automatic transmission for an electric bicycle, comprising: a motor which is driven by a battery; a driving member for driving a wheel of the bicycle with rotational force of the motor; a power transmitting means for transferring the rotational force of the motor to the driving member; an electronic gear shifting means for electronically shifting the output of the motor according to an magnitude of friction force between the wheel and ground; a moving housing in which the motor the driving member, the power transmitting means, the mechanical and electric gear shifting means are mounted; a fixed housing which is fixedly disposed at an outer side of the moving housing; and a first rotational shaft which penetrates through the driving member, the moving housing, and is rotatably fixed to the fixed housing, wherein, while the moving housing is revolved with the rotational shaft in the center according to the magnitude of load exerted on the wheel of the bicycle, the output of the motor is changed through the electronic gear shifting means and then transferred to the driving member.

It is to be understood that both the foregoing general description and following detailed description are exemplary and explanatory and are intended to provide further explanation of the invention as claimed.

### BRIEF DESCRIPTION OF THE DRAWINGS in the accompanying drawings:

FIG. 1 is a side view of an electric bicycle having a transmission according to the present invention;

FIG. 2 is a cross sectional view of a first embodiment of the transmission according to the present invention, in which a mechanical gear shifting means and an electronic gear shifting means are simultaneously employed;

FIG. 3 is a view showing a status that a moving housing is engaged with a fixed housing;

FIG. 4 is a flow chart showing a control state according to the present invention;

FIGS. 5A and 5B show an operation state of the first embodiment of the transmission according to the present invention, wherein FIG. 5A shows an operation state in a case that a load is not exerted on wheels of the electric bicycle and FIG. 5B shows an operation state in a case that a load is exerted on the wheels of the electric bicycle;

FIG. 6 is a cross sectional view of a second embodiment of the transmission according to the present invention, in which a mechanical gear shifting means is employed;

FIG. 7 is a cross sectional view of a third embodiment of the transmission according to the present invention, in which an electronic gear shifting means is employed;

FIGS. 8A and 8B show operation states of the fourth embodiment of the transmission according to the present invention, wherein FIG. 8A illustrates an operation state of a load not exerted on a wheel of the electric bicycle and FIG. 8B illustrates an operation state of a load exerted on a wheel of the electric bicycle:

FIG. 9 through FIG. 16 illustrate several embodiments according to the states concretely applied a driving member of the present invention device to the electric bicycle;

FIG. 9 is a side view showing a status that an automatic transmission according to the present invention is applied to a tire of the bicycle;

FIG. 10 is a cross-sectional view showing a status that the automatic transmission according to the present invention is engaged with the tire in FIG. 9;

FIG. 11 is a side view showing a status that the automatic transmission according to the present invention is applied to a chain of the bicycle;

FIG. 12 is a cross-sectional view showing a status that the automatic transmission according to the present invention is engaged with the chain in FIG. 11;

FIG. 13 is a side view showing a status that the automatic transmission according to the present invention is applied to a tire rim of the bicycle;

FIG. 14 is a cross-sectional view showing a status that the automatic transmission according to the present invention is engaged with the tire rim in FIG. 13;

FIG. 15 is a side view showing a status that the automatic transmission according to the present invention is applied to a rotational axis of the wheel of the bicycle;

FIG. 16 is a cross-sectional view showing a status that the automatic transmission according to the present invention is engaged with the rotational axis of the wheel in FIG. 15.

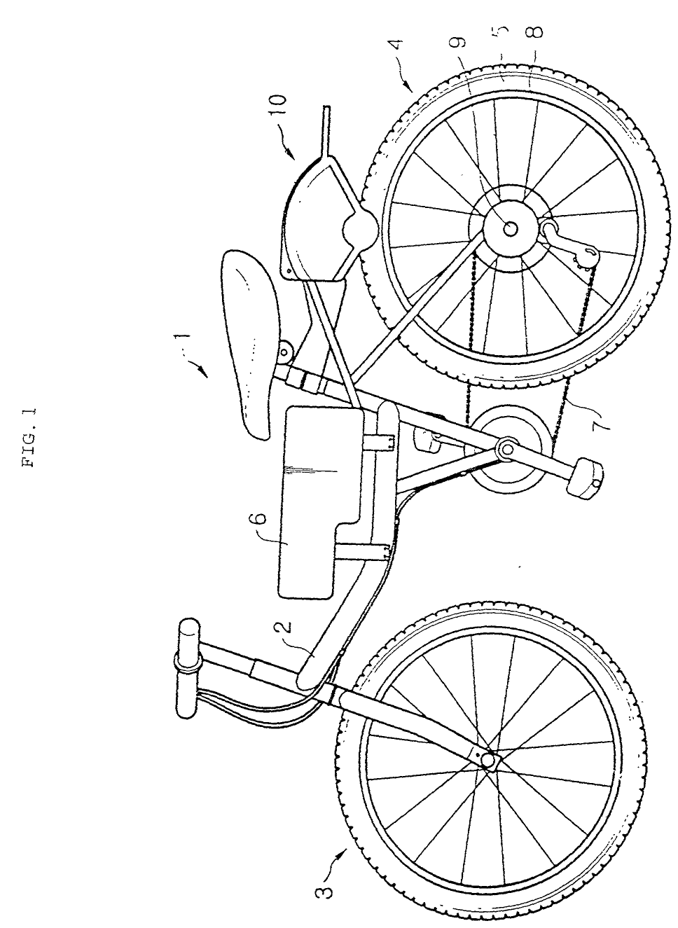

### DETAILED DESCRIPTION OF THE PREFERRED EMBODIMENT

Reference will now be made in detail to the preferred embodiment of the present invention, examples of which are illustrated in the accompanying drawing.

In the present invention, a bicycle is provided with two and three or more wheels.

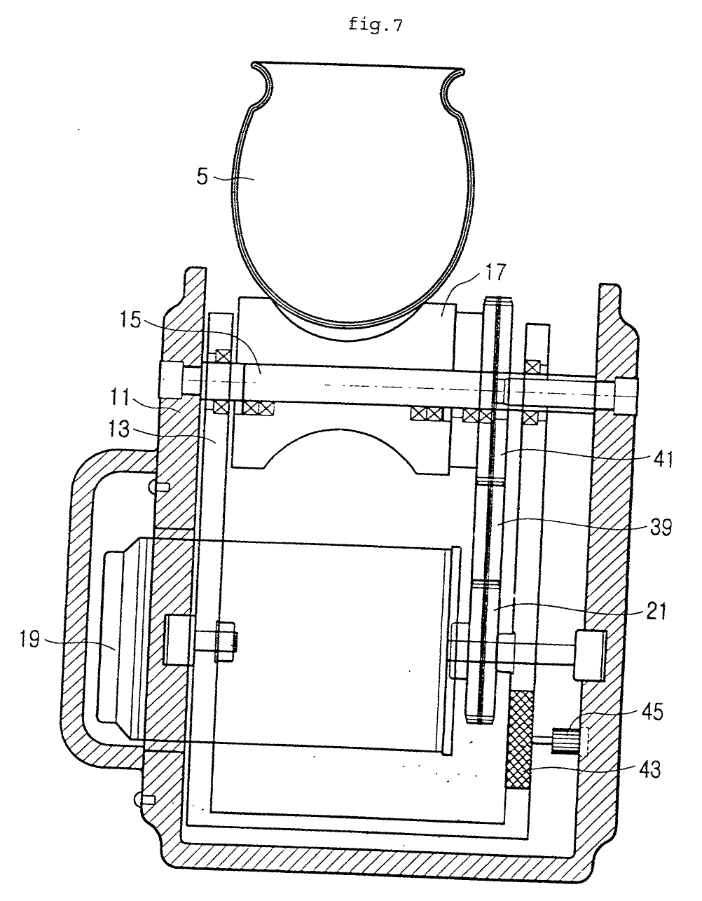

In a first embodiment of an electric bicycle 1 according to the present invention, the electric bicycle 1 is a two wheeled bicycle provided with a front and a rear wheel 3, 4 which are mounted at the front and rear sides of a main frame 2 thereof, as shown in FIG. 7.

A battery 6 is mounted on the main frame 2 so as to be connected with an automatic transmission 10 which is detachably engaged with a tire 5. The automatic transmission 10 is operated according to a load exerted on the wheel. A reference numeral 7 indicated a chain, 8 indicates a tire rim and 9 is a rotational shaft of the wheel.

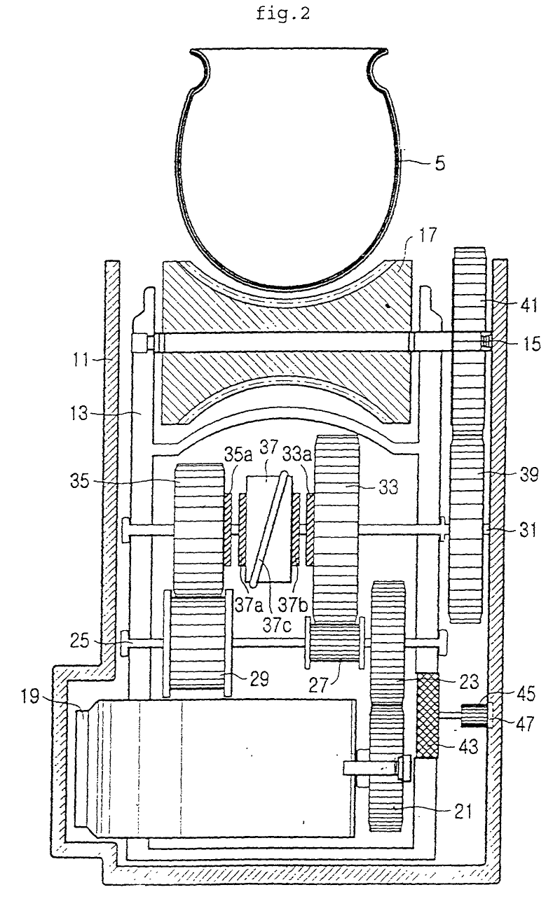

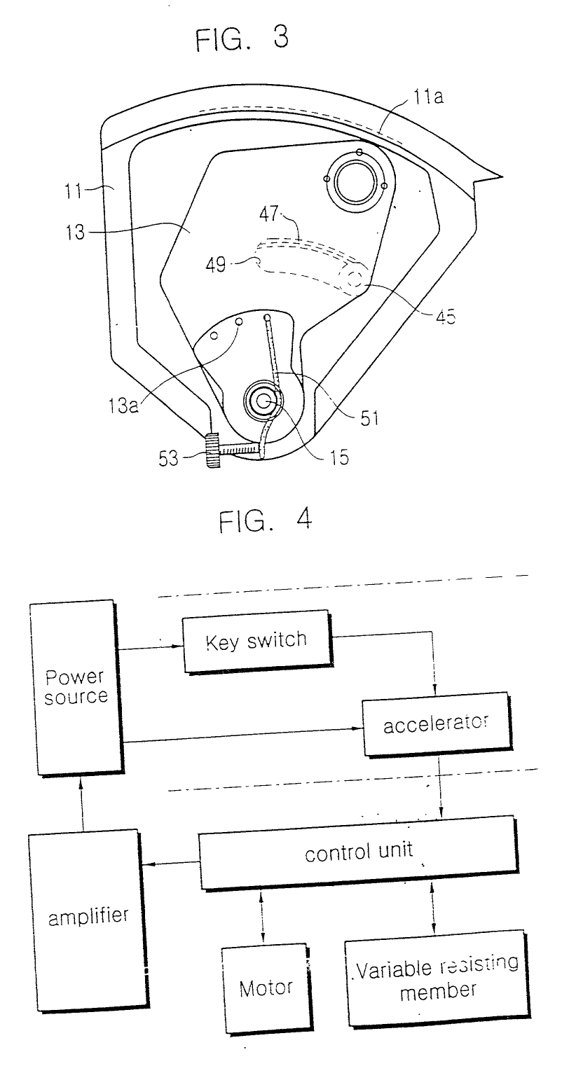

FIGS. 2 and 3 are views showing constructions of the automatic transmission 10 according to the first embodiment of the present invention. A moving housing 13 is rotatably disposed in a fixed housing so as to be capable of rotating with a first rotational shaft 15 of the moving housing 13 in the center. The first rotational shaft 15 of the moving housing 13 is formed with a friction gear 17 which is contacted with a surface of the tire so as to rotate the wheel. On the surface of the friction gear 17, there are provided uneven portions which are engaged with uneven portions of the tire to increase the frictional force between the friction gear 17 and the tire. Here, the uneven portions of the friction gear 17 have various shapes according to shapes of the uneven portions of the tire.

A DC motor 19 which receives a power source from a battery 6 is disposed at one side opposite to the friction gear 17 within the moving housing 13. The DC motor 19 is connected through a plurality of gears with the friction gear 17 so that a driving power is transferred from the DC motor 19 to the friction gear 17.

That is, a driving gear 21 is mounted at a driving shaft of the DC motor 19. The driving gear 21 is engaged with a first gear 23 which is rotatably mounted at a second rotational shaft 25. Further, the second rotational shaft 25 is provided with a first low gear 27 and a first high gear 29.

In addition, a third rotational shaft 31 is mounted in the moving housing 13 so as to be parallel with the second rotational shaft 25. The third rotational shaft 31 is also provided with a second low gear 33 and a second high gear 35 which are respectively corresponded to the first low gear 27 and the first high gear 29. At this time, each of the second low gear 33 and the second high gear 35 is provided with a bearing (not shown) therein so as to be capable of rotating about the third rotational shaft 31.

A clutch 37 is mounted between the second low gear 33 and the second high gear 35 of the third rotational shaft 31 in order to selectively transfer a driving power to the second low gear 33 and the second high gear 35. The clutch 37 is provided with friction plates 37a, 37b at both sides thereof. The second low gear 33 and the second high gear 35 also have friction plates 33a, 35a at each one side thereof, corresponding to friction plates 37a, 37b of the clutch 37.

On the outer surface of the clutch 37, there is provided a moving projection 37c in a diagonal direction so that the clutch 37 can be reciprocated between the second low gear 33 and the second high gear 35. A guiding groove 11a corresponding to the moving projection 37c is provided on the inner surface of the fixed housing 11. Therefore, when the moving housing 13 is moved, the moving projection 37c of the clutch 37 is guided along the guiding groove 11a of the fixed housing 11, whereby the clutch 37 is moved on the second rotational shaft 31. Here, since the clutch 37 is coupled with the second rotational shaft 31 by a key and a key way (not shown), the clutch 37 can be moved on the second rotational shaft 31 within a certain extent, and the second rotational shaft 31 is rotated by the rotation of the clutch 37.

A second gear 39 is mounted at one end of the third rotational shaft 31. A third gear 41 which is engaged with the second gear 39 is fixed at one end of the first rotational shaft 15 which is provided with the friction gear 17.

Meanwhile, a variable resisting member 43 is provided at a desired position of the moving housing 13. A pinion gear 45 is connected to the variable resisting member 43. A guiding groove 49 is provided on an inner surface of the fixed housing 11, corresponding to the pinion gear 45. A rack 47 is formed in the guiding groove 49 so as to be engaged with the pinion gear 45. Therefore, the pinion gear 45 is rotated according as the moving housing 13 is moved in the fixed housing 11, whereby a variable resisting value which is transferred to the motor 19 is changed.

The variable resisting member 45 is a load inducing part electronically inducing the load and FIG. 4 illustrates an operation of an electronic control. A power source is applied to a key switch in a driving mode of the bicycle running and to the accelerator thereof in an inactive condition of the brake, and adds or subtracts an output to the motor through the control part in the accelerator. In the driving mode, the magnitude of the load detected in the load inducing part is automatically controlled and adds or subtracts the output generated from the motor.

In a state of a charging mode when coming down a slope, a minute electric power, generated while driving the motor by the rotational axis of the bicycle wheels in the state of that the power source is not applied to the brake and the accelerator, is inputted to the control part. Thereupon, the control part charges the electric power by receiving a control signal for the mode key switch and by amplifying the inputted electric power through an amplifying part.

Further, in a charging mode which is in such state that the bicycle is run on an downhill road. The power source is not supplied to the accelerator. On the contrary, the motor is driven by the rotational force of the wheel and generates electric power. The electric power generated from the motor is input to the control unit. The control unit thus converts the running mode into the charging mode. The electric power is then amplified through an amplifier and charged into the battery.

In the first embodiment of the present invention, a plurality of gears are used as the power transmission means. However, a chain or belt can be also used in the present invention.

One end of the first rotational shaft 17 is fixed to the fixed housing 11 with a torsion spring 51. The other end of the first rotational shaft 17 is fixed to the moving housing 13. At this time, on the side of the moving housing 13, there is provided a plurality of holes 13a in which one end of the torsion spring 51 is fixed so as to regulate an elastic force of the torsion spring 51, thereby controlling a restoring force of the moving housing 13.

A spring regulating lever 53 is provided to the other end of the torsion spring 51 so that a driver can regulate the elastic force of the torsion spring.

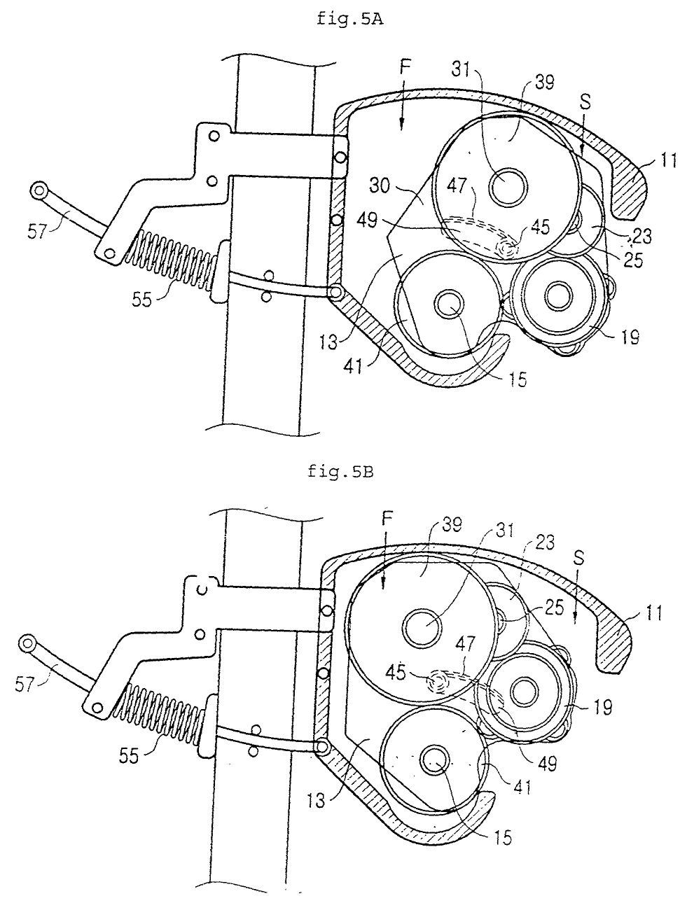

As shown in FIGS. 5A and 5B, the friction gear 17 mounted in the moving housing 13 can be contacted with or separated from the tire 5 by an elastic spring 55 which exerts a tension force in a direction that the friction gear 17 is contacted with the tire 5 and a tension rink 57 which controls the tension force of the elastic spring 55. A wire (not shown) is connected to the tension rink 57 so that the tension rink 57 can be controlled at one side of the handle of the bicycle or a pedal.

Referring to the FIGS. 5A and 5B, the operation of the one embodiment of the present invention will be described more fully.

When the bicycle is in a state of stopping or running on a downhill road, that is, when any load is not exerted on the wheel of the bicycle, the moving housing 13 is located at the place of “S”, as shown in FIG. 5A.

In other words, since the moving housing 13 is located at the place of “S” and the friction gear 17 is rotated by the tire 5, when the bicycle is running on the downhill road, the motor 19 is in the charging mode and the battery 6 is charged.

Meanwhile, when the bicycle is in a state of starting or running on an uphill road, a load is excessively exerted on the wheel of the bicycle, because of the increasing of the friction force between the tire 5 and he ground. Therefore, since a big reverse force is applied from the tire 5 to the friction gear 7, the moving housing 13 is revolved from “S” toward “F” with the first rotational shaft 15 in the center, due to the reverse force.

While the moving housing 13 is moved from the place of the “S” to “F” in the fixed housing 11, the moving projection 37c is slid in the guiding groove 11a. The clutch 37 is moved from the second high gear 35 of the third rotational shaft 31 to the second low gear 33 so that the friction plate 37b of the clutch 37 is engaged with the friction plate 33a of the second low gear 35. Therefore, the driving force is transferred as follows: the driving gear 21→the first gear 23→the second rotational shaft 25→the first low gear 27→the second low gear 33→the clutch 37→the third rotational shaft 31→the second gear 39→the third gear 41→the first rotational shaft→the friction gear 17. Thus, the output of the motor is changed from the state of the low speed to the high speed, thereby overcoming the reverse force which is applied from the tire 5 to the friction gear 17 and rotating the tire 5.

At the same time, since the pinion gear 45 of the variable resisting member 43 is rotating in the state of being engaged with the rack 47 which is provided at one side of the guiding groove 49 of the fixed housing 11, the variable resisting value is changed. The control unit detects the changed variable resisting value and controls the motor so that the output of the motor is increased.

According to the present invention, since the rotational force of the friction gear 17 is increased in a short time by the electronic gear shifting means using the variable resisting member 43 and the mechanical gear shifting means using the clutch 37, in case that the bicycle is in the state of starting or running on the uphill road, the automatic gear shifting operation is automatically performed without any troubles, thereby achieving a running at a constant speed.

As described above, if the reverse force exerted to the friction gear 17 is decreased, the moving housing 13 is returned from the place of “F” to the original place of “S” by the restoring force of the torsion spring 51 with the first rotational shaft 15 in the center.

When the moving housing is returned to the place of “S”, the clutch 37 is separated from the second low gear 33. The clutch 37 is then moved on the third rotational shaft 31 so as to be engaged with the second high gear 35. Since the output of the motor is changed its speed through a high gear ratio, the friction gear 17 rotates the tire 5.

Further, the pinion gear 45 of the variable resisting member is reversely rotated along the lack 47. Therefore, the resisting value for a low output is applied through the control unit to the motor 19.

In the embodiment of the present invention as described above, while the moving housing 13 is revolved between the place of “F” and “S” with the first rotational shaft 15 in the center by a reverse force which is exerted from the tire 5 to the friction gear 17 according to the friction force between the tire 5 and the ground, the mechanical gear shifting operation and the electronic gear shifting operation are automatically performed. Therefore, the friction gear 17 always rotates the tire with a constant force regardless of magnitude of the external force. Further, the bicycle can be run at a constant speed without any operating of the transmission.

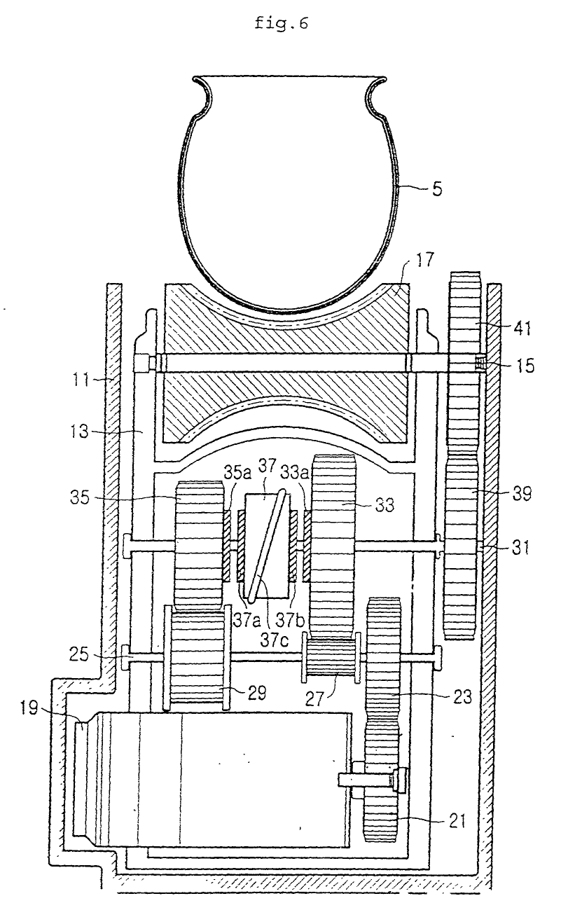

FIG. 6 shows a second embodiment of the transmission according to the present invention, in which only a mechanical gear shifting means is employed between the motor and the driving members.

The construction of the second embodiment according to the present invention is the same as the first embodiment of the transmission including the clutch 37 as the mechanical gear shifting means, and there is not provided the electronic gear shifting means. Here, the connecting condition between the moving housing and the fixed housing is the same as the first embodiment. And the construction of the elastic spring and the tension rink for removably contacting the fixed housing with the tire is also the same.

The operation of the second embodiment is the same as the operation of the first embodiment by the mechanical gear shifting means. Therefore, it is sure that the second embodiment also has an effect of automatically performing the running at a constant speed.

As shown in FIG. 7, the third embodiment of the present invention is provided with the variable resisting member as the electronic gear shifting moans, and there is not provided the mechanical gear shifting means including the clutch 37.

The operation and the effect of the third embodiment of the present invention is also the same as the first embodiment. The explanation thereof is omitted.

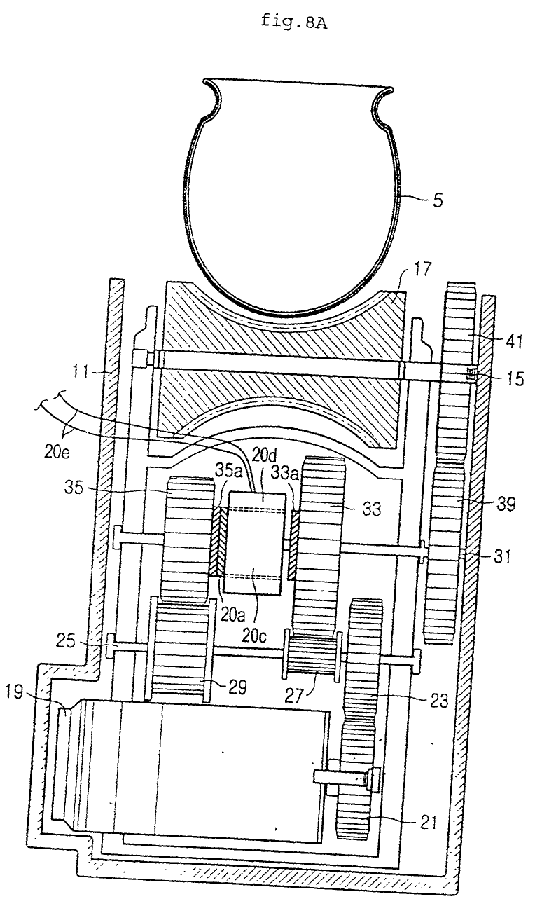

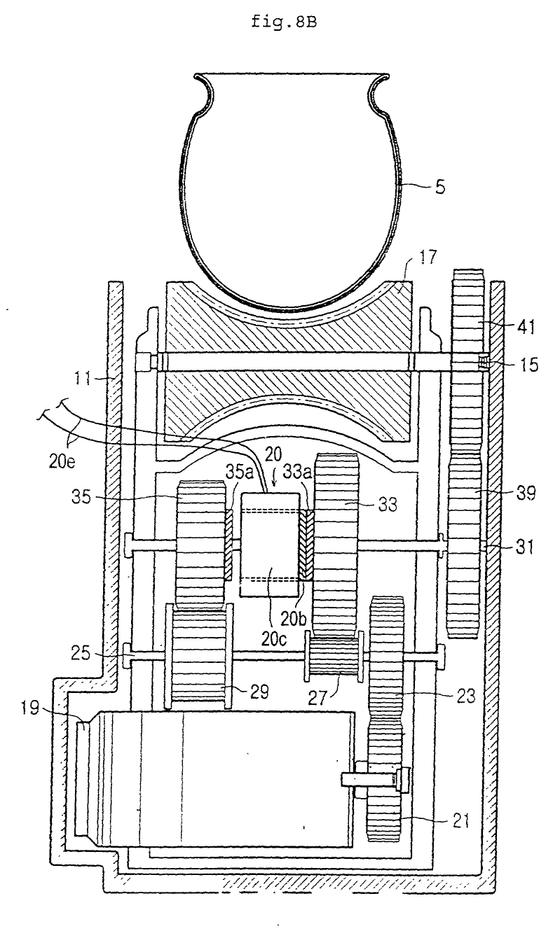

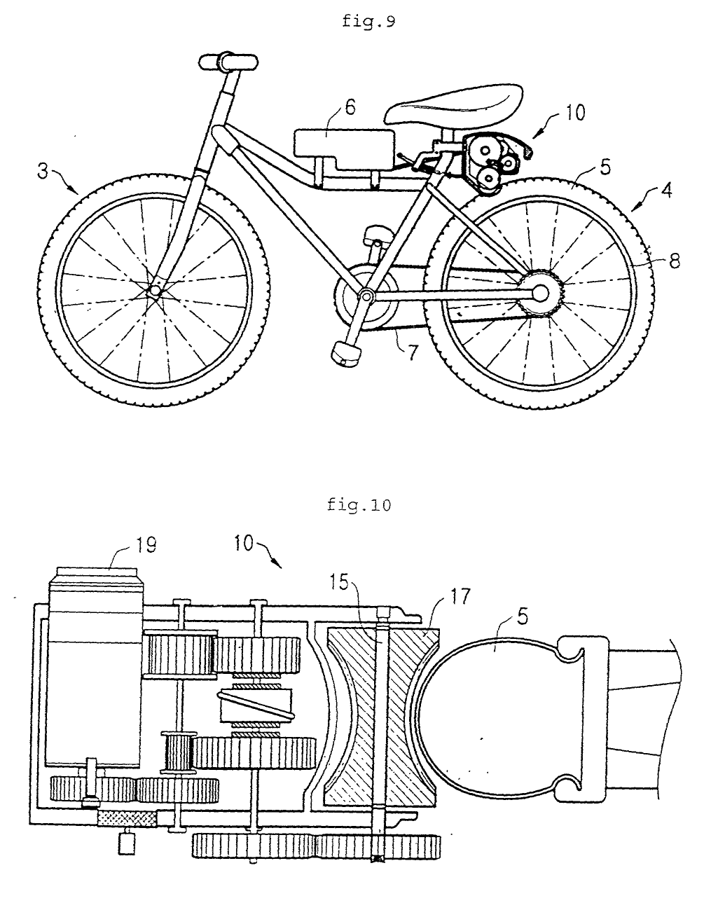

A fourth embodiment of the present invention as shown in FIGS. 8A and 8B illustrates that the clutch in the first and the second embodiments is replaced to an electronic clutch by the signal of the control part.

The clutch in the first and the second embodiments is replaced to the electronic clutch which adds the control part for controlling the electronic clutch instead of the moving housing 13 and guiding groove 49 for driving the clutch. The fourth embodiment of the present invention is referred to FIGS. 8A and 8B.

Referring to FIG. 8A, in the stopping state of the bicycle or in the free state from the load for the tire rotation when the driving down of the slope, an electronic clutch friction plate 20a keeps the state of being in gear with the friction plate 35a of the second high-speed gear by a spring (not shown) elasticity inside the electronic clutch housing 20d. The electronic clutch housing 20d is fixed on, a fixed housing 11. However, a friction plate part 20c is capable to freely move and rotate on the third rotational axis 31 in the moving section of the electronic clutch because that the friction plate part 20c and a third rotational axis 31 are coupled with a key and a key quirk, that the third rotational axis 31 is mounted to gear by the rotation of the friction plate part 20c and that a bearing is installed on the contact surface with the clutch housing 20d and the friction plate part 20c.

An electric power provided to the motor according to the magnitude of the load is changed because of exerting the load to rotate the tire 5 by a friction gear 17 at the starting point of the bicycle or in the driving up of the slope. When a variation of the electric power is over a predetermined value, a solenoid (not shown) inside the electronic clutch housing 20d operates by applying a power source to the electronic clutch 20 according to the signal of the control part (not shown) to detect the variation thereof. Thereby, the friction plate part 20c is moved from the second high-speed gear 35 to the second low speed gear 33 through a bearing (not shown) inside the electronic clutch housing 20d. Referring to FIG 8B, the electronic clutch friction plate 20a is separated from the friction plate 35a of the second high-speed gear and the friction plate 33a of the second low speed gear is coupled with the electronic clutch friction plate 20b. Therefore, the rotational driving force generated from the motor 19 is transferred by follows, the driving gear 21→the first gear 23→the second rotational axis 25→the first low gear 27→the second low sear 33→the electronic clutch 20→the third rotational axis 31→the second gear 39→the third gear 41→the first rotational axis 15→the friction gear 17. Thus, the output of the motor 19 is changed from the state of the high-speed to the low speed due to the rotational force of the first and the second low speed gears 27 and 35 by the friction gear 17, as a result, overcoming the affected force from the tire 5 to the friction gear 17 rotates the tire 5.

On the other hand, when the magnitude of the electric power provided to the motor 19 is below the predetermined value by decreasing the load exerted to the rotational axis of the bicycle due to the escape from a high load state, the power source of the electronic clutch 20 is blocked by the signal of the control part detecting the variation of the electric power and the friction plate part 20c is transferred from the second low speed gear 33 to the second high-speed gear 35 through the bearing inside the electronic clutch housing 20d by the spring elasticity installed with the solenoid inside the electronic clutch housing 20d. The electronic clutch friction plate 20b is separated from the friction plate 33a of the second low speed gear and the friction plate 35a of the second high-speed gear is connected with the friction plate 20a of the electronic clutch. The output of the motor 19 is changed to the rate of the high-speed gear, thereby; the friction gear 17 rotates the tire 5.

Like the above illustrations, the electronic clutch 20 automatically changes the speed by the detection of the variable load according to the driving condition of the bicycle and the signal of the control part according to the predetermined value. Thereby, the friction gear 17 rotates the tire 5 always at a regular force due to the possibility of the speed changing immediately on time and a driver drives automatically at a constant speed without any special operation.

Referring to the embodiments of the present invention, the change of the electric power value of the motor 19 is explained by the detection method of the load exerted on wheels of the bicycle. However, the same effect can be derived from a change of a voltage or a frequency, and a pneumatic or hydraulic force can be used instead of the solenoid as the driving device for the friction plate 20c inside the electronic clutch housing 20d.

The four illustrated embodiments of the present invention are explained as the desirable embodiments; however, the embodiment of the present invention is not limited but can be applied in every range of the technical idea of the present invention

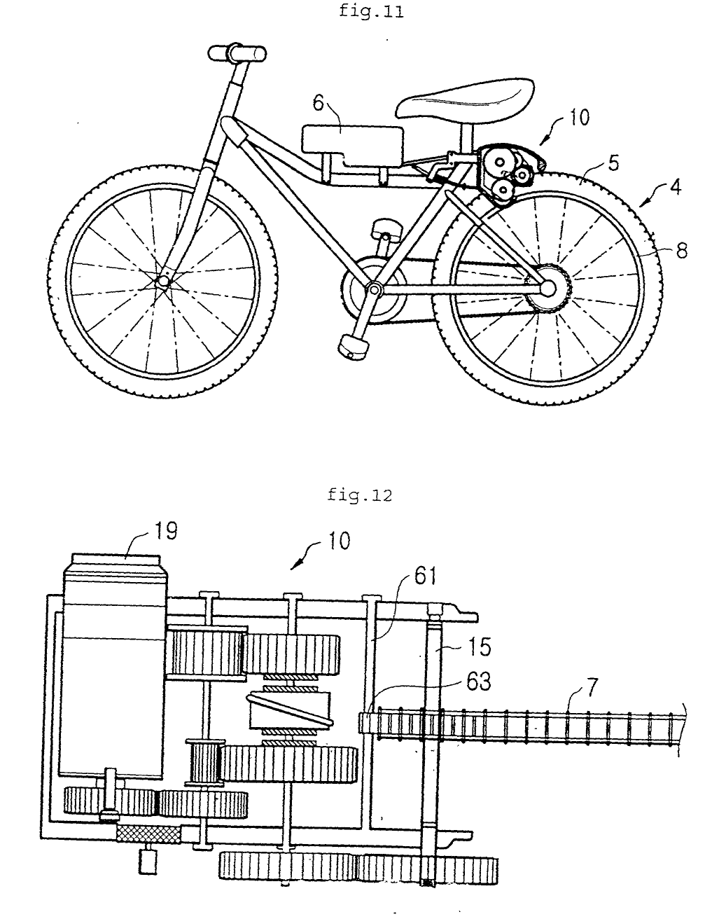

As shown in FIGS. 10 and 11, the driving member can be applied to the chain 7 of the bicycle.

That is, the chain 7 of the bicycle, as the driving member, is directly mounted at the first rotational gear 15. Therefore, the reverse force exerted on the wheel drives the transmission of the present invention through the chain 7. The operation of the embodiment is also the same as the first embodiment. However, in this embodiment, there is provided a chain supporting gear 61 on the first rotational shaft 15, in order to be contacted with the chain 7, thereby receiving or transferring the driving force from/to the motor.

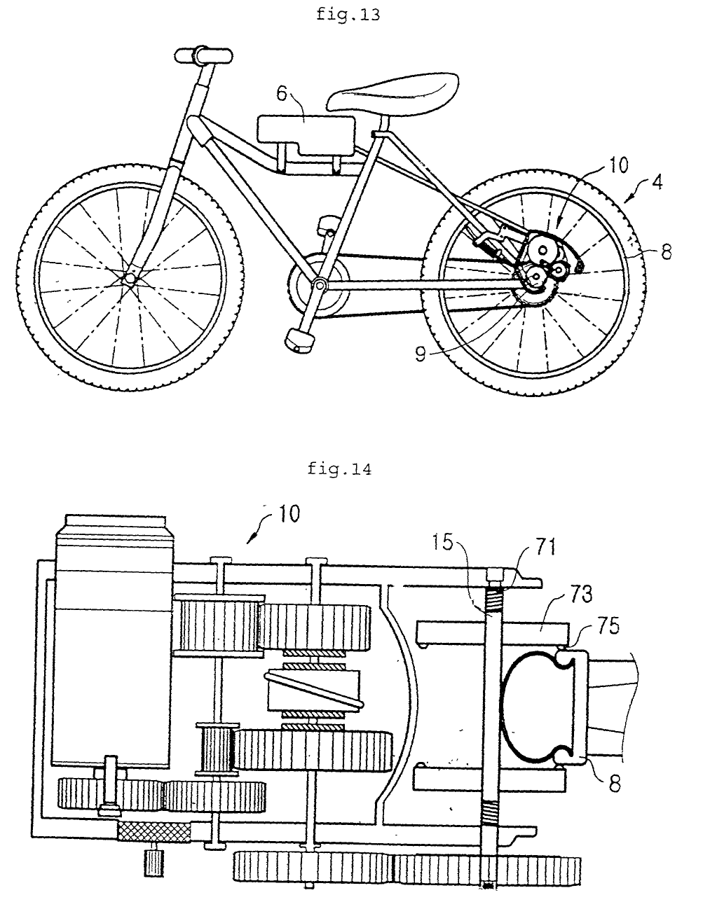

FIGS. 12 and 13 show a state that the transmission 10 of the present invention is applied to the tire rim 8.

In this embodiment, the tire rim 8 is compressively supported by two rotational bars 73 which are respectively mounted at both sides of the tire rim 8 on the first rotational shaft 15 with each elastic spring 71 by which the rotational bars 73 are elastically supported toward a renter of the first rotational shaft 15. In the rotational bars 73 and the first rotational shaft 15, there are respectively provided a key and a key way (not shown) so that the rotational bars it is fixed to be movable along the first rotational shaft 15. A hard rubber is provided on each inner face of the rotational bars 73 in order to contact with the tire rim 8.

According to the embodiment of the present invention, in the state of transferring the driving force -of the motor,, the rotational bars 73 are rotated by the first rotational shaft 15. Therefore, the wheel 4 is thus rotated through the tire rim 8 by the rotational bars 73. And if the reverse force exerted on the wheel 4 is increased, the transmission 10 responds to the reverse force through the tire rim 8 and performs the automatic gear shifting operation.

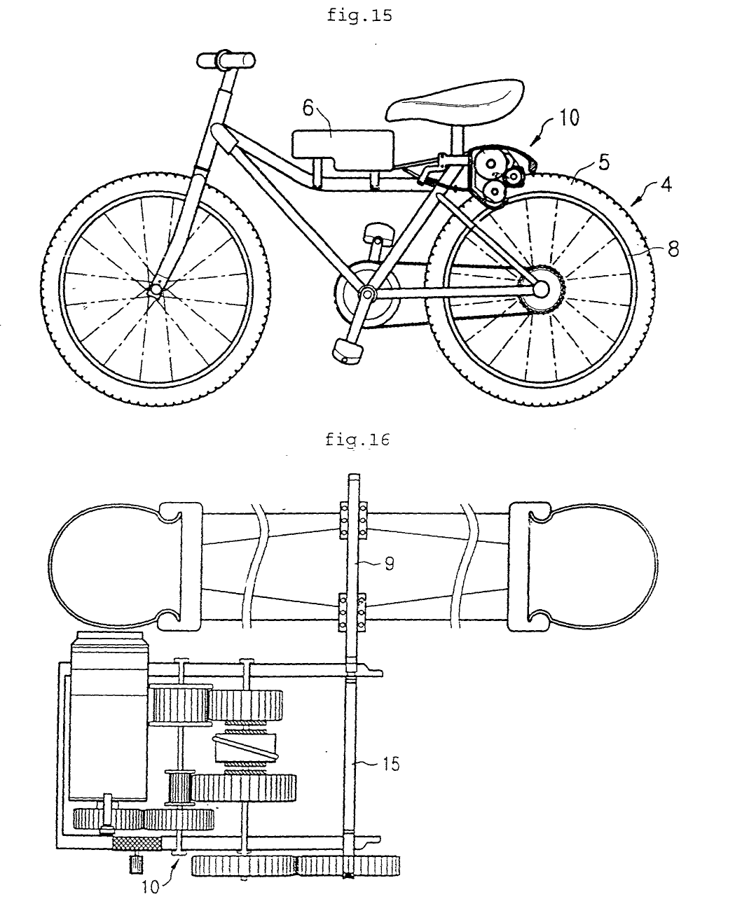

FIGS. 15 and 16 show states that the transmission 10 of the present invention is applied to a rotational axis of the wheel 4. Here, the rotational axis 9 of the wheel is coaxially connected with the first rotational axis 15 of the automatic transmission 10, thereby the reacted force on the wheel 4 induces the load through the rotational axis 9 for the automatic transmission.

According to the present invention, the automatic transmission 10 can be also provided on a front wheel of the bicycle.

It will be apparent to those skilled in the art that various modifications and variations of the present invention can be made without departing from the spirit or scope of the invention. Thus, it is intended that the present invention cover the modifications and variations of this invention provided they come within the scope of the appended claims and their equivalents.

What is claim is:

1. An automatic transmission for an electric bicycle, comprising:
a motor which is driven by a battery;
a driving member for driving a wheel of the bicycle with rotational force of the motor;
a power transmitting means for transferring the rotational force of the motor to the driving member;
a mechanical gear shifting means for mechanically shifting an output of the motor according to an magnitude of friction force between the wheel and ground and transferring the shifted output of the motor to the driving member;
an electronic gear shifting means for electronically shifting the output of the motor according to an magnitude of friction force between the wheel and ground;
a moving housing in which the motor, the driving member, the power transmitting means, the mechanical and electric gear shifting means are mounted;
a fixed housing which is fixedly disposed at an outer side of the moving housing; and
a first rotational shays which penetrates through the driving member, the moving housing, and is rotatably fixed to the fixed housing;
wherein, while the moving housing is revolved with the rotational shaft in the center according to the magnitude of load exerted on the wheel of the bicycle, the output of the motor is changed through the mechanical and electronic gear shifting means and then transferred to the driving member.

2. The automatic transmission of the claim 1, wherein the driving member is a friction gear having uneven portions which are engaged with uneven portions of the tire in order to drive the wheel.

3. The automatic transmission of the claim 1, wherein the driving member is a chain gear which is mounted on the first rotational shaft, and is contacted with a chain of the bicycle so as to drive the wheel.

4. The automatic transmission of the claim 1, wherein the driving member is two rotational bars which are mounted at the rotational shaft and support a tire rim of the wheel as both side of the tire rim.

5. The automatic transmission of the claim 1 wherein the first rotational shaft is coaxially connected with a rotational shaft of the wheel so as to directly drive the wheel.

6. The automatic transmission of the claim 1, wherein the power transmitting means comprises a driving gear which is mounted at a shaft of the motor and a plurality of gears which are rotated by the driving gear and thus transfers a rotational force to the driving member.

7. The automatic transmission of the claim 1, wherein the mechanical gear shifting means comprises a first low gear and a first high gear which are mounted at a second rotational shaft, the second rotational shaft being rotated by a first gear which is driven by a driving gear of the motor; the second low gear and a second high gear which are rotatably mounted at a third rotational shaft parallel with the second rotational shaft and which are respectively engaged with the first low gear and the first high gear; a clutch which is selectively connected with the second low gear and the second high gear so as to transfer a driving power to one of the second low gear and the second high gear.

8. The automatic transmission of the claim 7, wherein the clutch is provided with a moving projection in a diagonal direction on an outer surface thereof, and a guiding groove corresponding to the moving projection is provided on an inner surface of the fixed housing so that the clutch can be selectively moved to the second low gear or the second high gear according to the magnitude of a load exerted on the wheel when the moving housing is revolved in the fixed housing.

9. The automatic transmission of the claim 1, wherein electronic gear shifting means comprises a variable resisting member which regulates a rotational forte of the driving member according to the magnitude of the magnitude of a load exerted on the wheel.

10. The automatic transmission of the claim 9, wherein the variable resisting member is provided with a pinion gear in the center thereof, a rack which is engaged with the pinion gear is provided on an inner surface of the fixed housing so that a variable resisting value of the variable resisting member is changed according to the magnitude of a load exerted on the wheel when the moving housing is revolved in the fixed housing.

11. The automatic transmission of the claim 1, wherein the moving housing is elastically connected through an elastic member with the fixed housing so that a restoring force is always applied to the moving housing.

12. The automatic transmission of the claim 11, wherein the elastic member is provided with a regulating lever which is provided to one end of the elastic member so that a driver can regulate an elastic force of the elastic member.

13. The automatic transmission of the claim 1, further comprising a removing means which is mounted at the fixed housing and which removably contacts the moving housing with the tire.

14. The automatic transmission of claim 1, further comprising:
an operation part for controlling a driving condition of the bicycle when applying the power source with comprising a key switch, a brake and an accelerator;
a control unit or increasing or decreasing a driving speed of the bicycle by running the motor according to a signal of the control part;
an amplifying part for charging an electric power to the electric power by amplifying an electric current generated from the wheels of the bicycle to the motor.

15. An automatic transmission for an electric bicycle, comprising:
a motor which is driven by a battery,
a driving member for driving a wheel of the bicycle with rotational force of the motor;
a power transmitting means for transferring the rotational force of the motor to the driving member;
a mechanical gear shifting means for mechanically shifting an output of the motor according to an magnitude of friction force between the wheel and ground and transferring the shifted output of the motor to the driving member;
a moving housing in which the motor, the driving member, the power transmitting means, the mechanical gear shifting means are mounted;
a fixed housing which is fixedly disposed at an outer side of the moving housing; and
a first rotational shaft which penetrates through the driving member, the moving housing, and is rotatably fixed to the fixed housing;
wherein, while the moving housing is revolved with the rotational shaft in the center according to the magnitude of load exerted on the wheel of the bicycle, the output of the motor is changed through the mechanical gear shifting means and then transferred to the driving member.

16. The automatic transmission of the claim 15, wherein the mechanical gear shifting means comprises a first low gear and a first high gear which are mounted at a second rotational shaft, the second rotational shaft being rotated by a first gear which is driven by a driving gear of the motor; a second low gear and a second high gear which are rotatably mounted at a third rotational shaft parallel with the second rotational shaft and which are respectively engaged with the first low gear and the first high gear; a clutch which is selectively connected with the second low gear and the second high gear so as to transfer a driving power to one of the second low gear and the second high gear.

17. The automatic transmission of the claim 16, wherein the clutch is provided with a moving projection in a diagonal direction on an outer surface thereof, and a guiding groove corresponding to the moving projection is provided on an inner surface of the fixed housing so that the clutch can be selectively moved to the second low gear or the second high gear according to the magnitude of a load exerted on the wheel when the moving housing is revolved in the fixed housing.

18. An automatic transmission of an electric bicycle, comprising:
a motor which is driven by a battery;
a driving member for driving a wheel of the bicycle with rotational force of the motor;
a power transmitting means for transferring the rotational force of the motor to the driving member;
an electronic gear shifting means for electronically shifting the output of the motor according to an magnitude of friction force between the wheel and ground;
a moving housing in which the motor, the driving member, the power transmitting means, the mechanical and electric gear shifting means are mounted;
a fixed housing which is fixedly disposed at an outer side of the moving housing; and
a first rotational shaft which penetrates through the driving member, the moving housing, and is rotatably fixed to the fixed housing;
wherein, while the moving housing is revolved with the rotational shaft in the center according to the magnitude of load exerted on the wheel of the bicycle, the output of the motor is changed through the electronic gear shifting means and then transferred to the driving member.

19. The automatic transmission of the claim 18, wherein the electronic gear shifting means comprises a variable resisting member which regulates a rotational force of the driving member according to the magnitude of the magnitude of a load exerted on the wheel.

20. The automatic transmission of the claim 19, wherein the variable resisting member is provided with a pinion gear in the center thereof, a rack which is engaged with the pinion gear is provided on an inner surface of the fixed housing so that a variable resisting value of the variable resisting member is changed according to the magnitude of a load exerted on the wheel when the moving housing is revolved in the fixed housing.

21. An automatic transmission of an electric bicycle, comprising:
a motor driven by a battery;
a driving member for driving the wheels of the bicycle by a rotational force of the motor;
a motive power transmitting device for transmitting the rotational force of the motor to the driving member;
an electronic transmission device for transmitting the motive power outputted from the motor according to a magnitude of the friction force between the wheels and the ground to the driving member by an electronic clutch; and
a fixed housing comprising the motor, the driving member, the motive power transmitting device and electronic transmitting device.

22. The automatic transmission of claim 21, wherein the electronic transmission comprising:
a first low-speed gear and a first high-speed gear, installed on a second rotational axis which is rotated by a first gear by rotating the driving member;
a second low-speed gear and a second high-speed gear, installed to be capable of the rotation on the second rotational axis in parallel and coupled with the first low-speed gear and the first high-speed gear;
an electronic clutch, for controlling the rotational force of the driving member according to the magnitude of the friction between the wheels and the ground by rotating a third rotational axis which is connected to the rest of the gear while connected selectively to the second low-speed gear and the second high-speed gear.

23. The electronic clutch of claim 21, wherein the electronic clutch comprises a solenoid for driving the friction plate, a spring for returning the friction plate to the original place at the end of the solenoid driving, and the friction plate for transmitting the motive power operated by the solenoid and the spring.
